(19) United States
(12) Patent Application Publication
(10) Pub. No.: US 2004/0103302 A1
(43) Pub. Date: May 27, 2004

(54) Security-protected hard disk apparatus and method thereof

(76) Inventors: Hiroyuki Yoshimura, Tokyo (JP); Kiminori Sato, Nagano (JP)

Correspondence Address: ROSSI & ASSOCIATES, P.O. Box 826, Ashburn, VA, 20146-0826, US

(21) Appl. No.: 10/622,016

(22) Filed: Jul. 17, 2003

(30) Foreign Application Priority Data
Jul. 18, 2002 (JP) 2002-210183
Jan. 24, 2003 (JP) 2003-016581

(51) Int. Cl. G06F 12/14

(52) U.S. Cl. 713/200

(57) ABSTRACT

A security-protected hard disk apparatus prevents illegal access by providing a container with substance that renders the magnetic storage medium unreadable or useless in the enclosure that houses the magnetic storage medium in response to opening of the enclosure.

### BACKGROUND

Today's terminal devices, such as personal computers and the like, allow easy access to various contents installed in a hard disk apparatus (or by downloading the contents into the hard disk apparatus via the Internet or a network). Therefore, because those contents are easily available and accessible, it is becoming increasingly difficult to prevent illegal use.

To prevent illegal use or access, an ID number/password authorization key has been contemplated so that only the authorized user can have access to such contents. The problem, however, is that the authorized user can forward his ID number/password to a third party (or the third party can obtain the ID number/password). This allows the third party full access to the content as if he were the authorized user. As a new countermeasure, embedding an ID individually into the storage medium has been proposed, so that the contents can be accessed only when a contents key required for accessing the contents is produced based on the ID, as disclosed in JP-A-2000-298942. This arrangement can prevent even the seasoned hackers from accessing the contents as long as the ID embedded in the medium cannot be accessed.

Even with the above countermeasure, it remains technically possible for hackers (i.e., those having special knowledge) to lift the contents key or the ID by disassembling the hard disk apparatus, reading the stored contents on the storage surface of the storage medium by using a magnetic head, and performing a signal processing or the like to extract the contents, especially the copyright protected ones. Accordingly, to further advance contents delivery via the Internet or the like, there remains a need for a highly reliable system that can completely protect the contents from unauthorized access. The present invention addresses this need.

### SUMMARY OF THE INVENTION

The present invention relates to a security-protected hard disk apparatus/method that disables reading of information stored in a magnetic storage medium of a hard disk apparatus when an unauthorized user attempts to obtain such information illegally by disassembling the storage medium.

One aspect of the present invention is a security-protected hard disk apparatus that includes a magnetic storage medium, a first container containing a substance renders the magnetic storage medium unreadable or unusable when applied thereto, an enclosure enclosing the magnetic storage medium and the container, and releasing means for releasing the substance in the first container to the surface of the magnetic storage medium in response to opening of the enclosure to render the magnetic storage medium unreadable or unusable.

The enclosure can be sealed to maintain a set pressure, and the pressure in the enclosure can be set substantially the same as that of the container, but higher than the ambient or atmospheric pressure. The release means releases the substance when the pressure in the container is higher than the pressure in the enclosure, such as when the case is opened, penetrated or otherwise exposed to the ambient or atmospheric pressure.

Alternatively, the pressure in the enclosure can be set lower than the ambient or atmospheric pressure. Specifically, the enclosure can include an inner enclosure sealingly enclosing the container and the magnetic storage medium, and an outer enclosure sealingly enclosing the inner enclosure. The inner enclosure can include a movable portion adapted to press or squeeze the container when the pressure in the outer enclosure becomes higher than the pressure in the inner enclosure, e.g., such as when the outer enclosure becomes exposed to the ambient or atmospheric pressure. The pressure in the outer and inner enclosures can be set lower than the ambient or atmospheric pressure.

The enclosure can have a lid that closes the enclosure, and a fastener that secures the lid. The releasing means can include the fastener and an interlocking mechanism connected to the fastener and to the container, the interlocking mechanism allowing the fastener to be inserted inwardly and pressing the container to release the substance when an attempt is made to move the lid by releasing the fastener outwardly.

The container can include a port, which is arranged to face the surface of the magnetic storage medium. The port can include a seal that can open or unseal using the pressure difference between the container and the ambient or atmospheric pressure surrounding the container. For instance, the seal can open when the pressure in the container is greater than the surrounding pressure, such as when the movable portion or the interlock mechanism presses or squeezes the sealed container.

The release means can include a sensor for detecting opening of the enclosure and a valve-actuating unit with a valve based on the detection of the opening. The valve-actuating unit with the valve can be associated with the container to release the substance.

The enclosure also can contain a second container containing a neutralizer for neutralizing the substance in the first container and neutralizer releasing means for releasing the neutralizer in the second container to the surface of the magnetic storage medium in response to opening of the enclosure. The substance can be acid, such as in a form of acidic solution, for dissolving a storage layer of the magnetic recording medium. The substance also can include fine particles that adhere to the surface of the magnetic storage medium. The neutralizer can be alkaline, such as in a form of alkaline solution or alkaline powder, for neutralizing the acid.

The alkaline releasing means can release the alkaline after a predetermined period elapses after the acid is released. The acid releasing means and the alkaline releasing means each can be associated with a sensor for detecting opening of the enclosure, and include a heater for heating the respective first or second container to release the content therein based on the detection of the enclosure opening. The heater of the second container can heat after a predetermined period lapses after the detection of the enclosure opening.

Each of the first and second containers can have a double-walled configuration, which includes an internal container and an outer container enclosing the internal container. The internal container can sealingly contain the respective acid or alkaline at a pressure of 1 ATM or higher, and can include the heater for heating at least a portion of the internal container and unsealing the internal container. The acid releasing means can include a nozzle pipe having a plurality of nozzles opening toward the surface of the magnetic storage medium, and piping connecting the nozzle pipe to an outlet of the outer container of the first container, and the alkaline releasing means includes piping connecting the nozzle pipe to an outlet of the outer container of the second container.

Alternatively, only the first container for the acid can have the double-walled configuration. In this alternative configuration, the acid releasing means can include a nozzle pipe having a plurality of nozzles opening toward the surface of the magnetic storage medium, and piping connecting the nozzle pipe to the outlet of the outer container of the first container. The alkaline releasing means can also include piping for connecting the nozzle pipe to the outlet of the alkaline container.

At least the inner containers of the first and second containers, or the second container and the inner container of the first container, can be formed of glass, ceramic, or polymer resin.

Another aspect of the present invention is a security-protected hard disk apparatus as disclosed above, but without the magnetic storage medium, i.e., security enclosure for a magnetic storage medium,.

Another aspect of the present invention is a method of disabling a magnetic storage medium to prevent unauthorized reading or access thereof. The method includes enclosing the magnetic storage in an enclosure, providing in the enclosure a container containing a substance that renders the magnetic storage medium unreadable or unusable when applied thereto, and releasing the substance in the container to the surface of the magnetic storage medium when the enclosure is opened or exposed to the ambient or atmospheric pressure to render the magnetic storage medium unreadable or unusable.

The method can further include the step of releasing a neutralizer at least to the magnetic storage medium to release the substance. The neutralizing step can release the neutralizer to the inside of the enclosure to neutralize the substance.

### BRIEF DESCRIPTION OF THE DRAWINGS

FIG. 1 schematically illustrates a cross-sectional view of a hard disk apparatus according to a first embodiment of the present invention.

FIG. 2A schematically illustrates a cross-sectional view of a solution container in a sealed state that can be used with the hard disk apparatus according to the present invention.

FIG. 2B schematically illustrates a cross-sectional view of the solution container of FIG. 2A in an opened state.

FIG. 3 schematically illustrates a cross-sectional view of another embodiment of the solution container.

FIG. 4 schematically illustrates a cross-sectional view of a hard disk apparatus according to a second embodiment of the present invention.

FIG. 5A illustrates a cross-sectional side view of a hard disk apparatus according to a second embodiment of the present invention in the vicinity of the solution container.

FIG. 5B illustrates a cross-sectional plan view of the hard disk apparatus of FIG. 5A.

FIG. 6 schematically illustrates a cross-sectional view of a hard disk apparatus according to a third embodiment of the present invention.

FIG. 7 schematically illustrates an enlarged cross-sectional view of the latchet mechanism in the hard disk apparatus illustrated in FIG. 6.

FIG. 8 schematically illustrates a cross-sectional view of a hard disk apparatus according to a fourth embodiment of the present invention.

FIG. 9 schematically illustrates a cross-sectional view of a hard disk apparatus according to a fifth embodiment of the present invention.

FIG. 10 schematically illustrates a cross-sectional view of a double-walled solution container that can be used with the present hard disk apparatus.

FIG. 11 schematically illustrates a time chart showing a sample energization timing to a heater.

FIG. 12 schematically illustrates a cross-sectional view of a hard disk apparatus according to a sixth embodiment of the present invention.

FIG. 13 schematically illustrates a cross-sectional view of a hard disk apparatus according to a seventh embodiment of the present invention.

FIG. 14 schematically illustrates a cross-sectional view of a single-walled powder container that can be used with the present hard disk apparatus.

### DETAILED DESCRIPTION

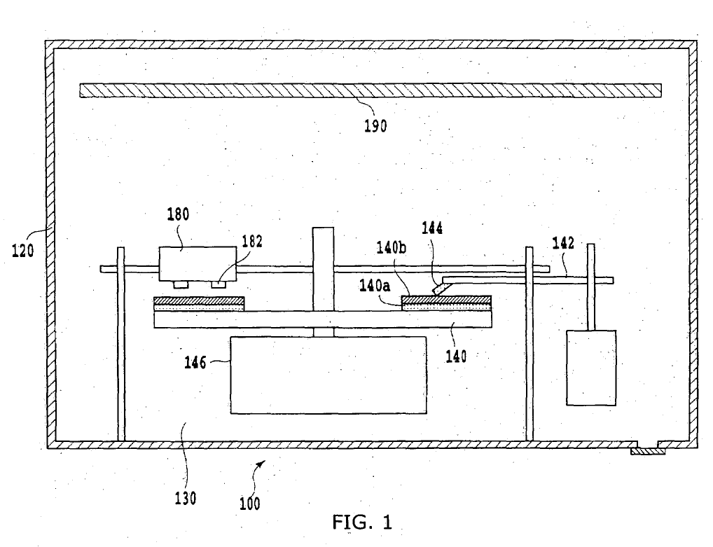

Referring to FIG. 1, a hard disk apparatus 100 according to a first embodiment of the present invention includes a sealed enclosure 120 that can be maintained at a predetermined pressure, enclosing a hard disk 140, which can be a Magnetic storage medium, a head arm 142, a magnetic head 144, a spindle motor 146 for driving the hard disk 140, and a circuit board 190 for controlling the hard disk apparatus 100. According to the present invention, the enclosure 120 also houses a sealed solution container 180 that contains a substance that can render the magnetic storage medium unreadable or useless. For instance, the container 180 can contain a solution that can reach and melt or dissolve at least the magnetic layer 140a of the magnetic storage medium at a high pressure. The solution container 180 can be arranged opposite to the main surface of the hard disk, namely adjacent to the main surface of the magnetic layer 140a and the lubricant layer 140b covering the magnetic layer 140a of the magnetic storage medium 140.

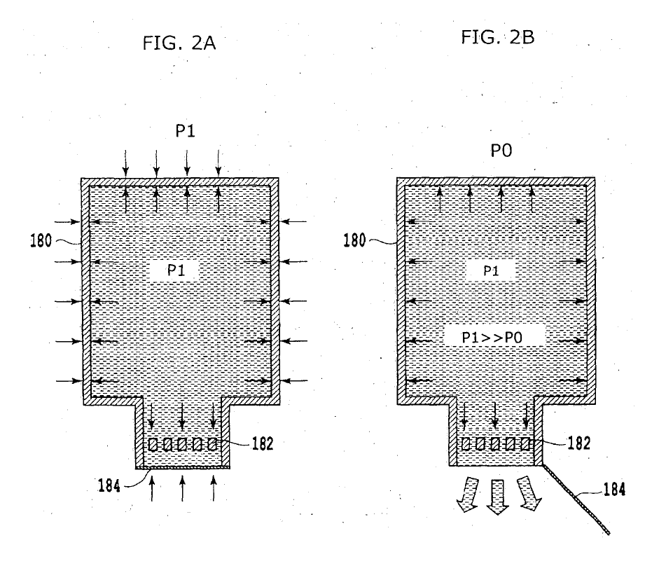

The container 180 is provided with an injection port 182 directed toward the storage layer side of the magnetic storage medium so that a solution can be injected at least to the main surface of the magnetic storage medium. The injection port 182 can be provided with a sealing film 184, which corresponds to a sealing device to be opened by the pressure difference, for sealing an extremity thereof during normal operation, as shown in FIG. 2A. When the hard disk apparatus is assembled, the pressure in the enclosure 120 is set to a pressure that is substantially the same as that in the solution container 180, but higher than the ambient or atmospheric pressure, so that the solution container 180 is not subjected to ambient pressure fluctuations.

In the hard disk apparatus 100 according to the first embodiment of the present invention, when the enclosure 120 is opened or exposed to ambient for sealing the contents, the pressure in the enclosure 120 equalizes with the ambient or atmospheric pressure, reducing the pressure of the sealed state. Because the pressure in the solution container 180 now is higher than the ambient or atmospheric pressure, the sealing film 184, which is designed to open, break,, or rupture when the solution container is exposed to the ambient pressure, exposes the solution contained therein onto the main (recording) surface of the magnetic recording medium 140, as illustrated in FIG. 2B. The solution spills out and is dispersed from the injection port 182, and is spread onto the main (recording) surface of the magnetic storage medium 140, and melts or dissolves the magnetic layer 140a and the lubricant layer 140b to disable at least the correct reading of the magnetic storage medium 140. The solution can be chemicals of acidic and organic solvent (e.g., hydrochloric acid).

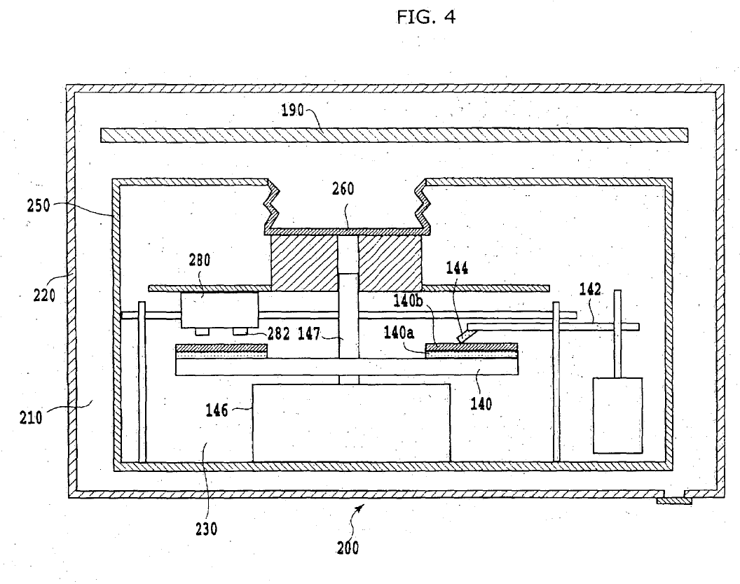

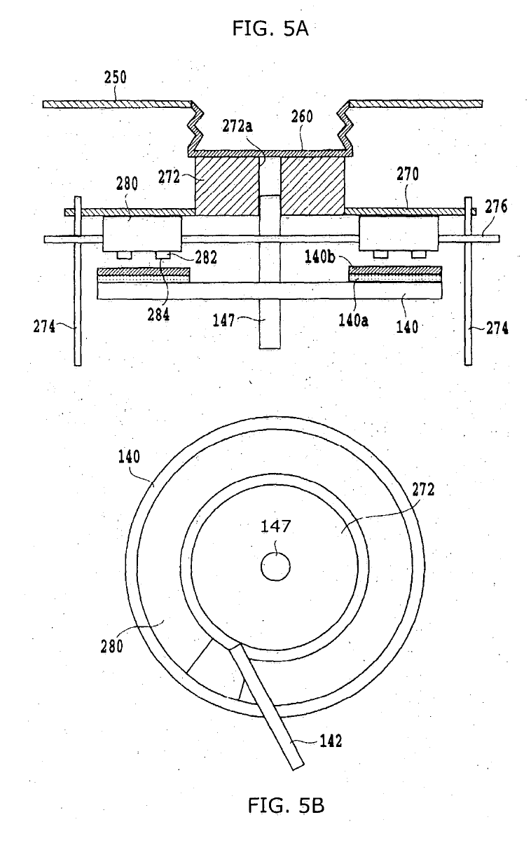

Referring to FIGS. 4, 5A, and 5B, a hard disk apparatus 200 according to a second embodiment of the present invention has a sealed dual-chamber structure 220, 250. More specifically, it has a sealed outer enclosure 220 covering an inner enclosure 250, which substantially corresponds to the enclosure 120 of the first embodiment (FIG. 1). The dual-chamber structure forms an inner pressure-sealed chamber 230 formed within the inner enclosure 250 and an outer pressure-sealed chamber 210 formed between the inner enclosure 250 and the outer enclosure 220. The inner enclosure 250 accommodates the components, such as the hard disk 140, the head arm 142, the magnetic head 144, etc., as described in the first embodiment (corresponding parts are represented by the same reference numerals).

The inner enclosure 250 of the second embodiment has a movable portion 260, which can press a solution container 280, on part of a wall surface thereof. The movable portion 260 in a form of a bellows formed of rubber material or other elastic material to ensure a large, stable amount of displacement due to the pressure difference between the outer pressure-sealed chamber 210 and the inner pressure-sealed chamber 230.

As FIGS. 4, 5A, and 5B show in detail, a disk-shaped interlocking plate 270 having substantially the same size as a magnetic storage medium 140 is fixed to the center of the movable member 260 via a main shaft 272 in a face-to-face relation with the main surface of the hard disk 140. The main shaft 272 has a guiding hole 272a at its center. The guide hole 272a is configured to slide a shaft 147 of the spindle motor 146. The interlocking plate 270 is mounted to the back surface of the solution container 280 supported by a fixed plate 276. The interlocking plate 270 can be adapted to be guided by a plurality of side columns 274 for smooth vertical movement thereof, as shown in FIG. 5A.

The solution container 280 can be formed of a flexible material capable of being pressed by the movable portion 260, via the interlocking plate 270, and can be formed with an injection port 282 facing the main surface of the magnetic storage medium 140. The injection port 282 can be provided with a sealing film 284, which corresponds to the sealing device 184 actuable by the pressure difference, similarly as disclosed in the first embodiment. The hard disk apparatus 200 is constructed so that the pressure in the inner enclosure 250 is substantially the same as in the solution container 280. The pressure in the inner enclosure 250 and the pressure in the outer enclosure 220 can be lower than the ambient or atmospheric pressure when they are assembled.

In the hard disk apparatus 200 constructed as described above, when the outer enclosure 220 is opened, the pressure in the outer pressure-sealed chamber 210 becomes the ambient or atmospheric pressure, and a force generated by the pressure difference is exerted to the movable portion 260 provided on the wall surface of the inner enclosure, 250 to move the movable portion 260 toward the recording medium 140. Movement of the movable portion 260 presses the back surface of the solution container 280 via the interlocking plate 270, so that the pressure therein increases. The injection port 282 provided at the extremity of the container opens by peeling or breaking the sealing film 284. Then, as in the first embodiment, the solution is dispersed out from the injection port 282 onto the main surface of the magnetic storage medium 140 to melt or dissolve the magnetic layer 140a/the lubricant layer 140b and disable the magnetic recording medium 140.

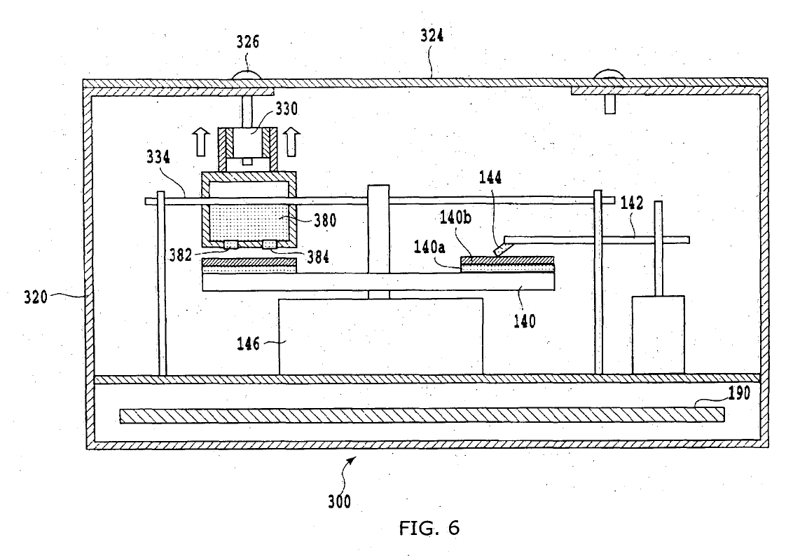

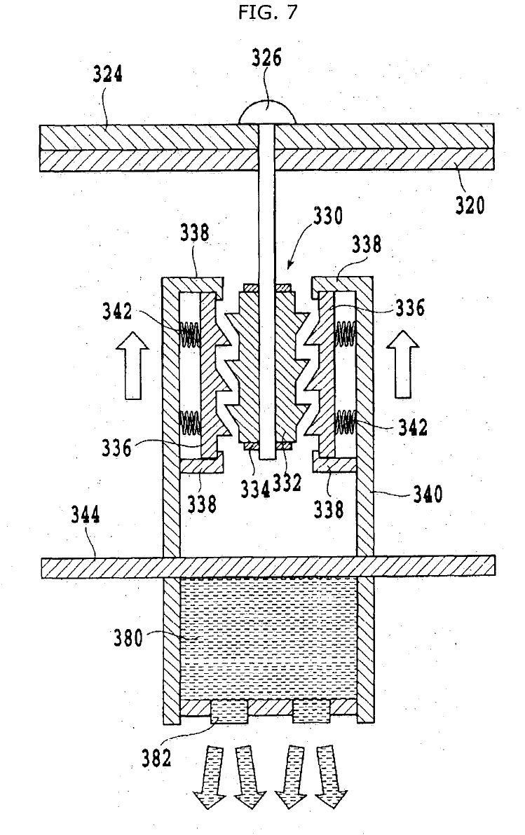

In the first and the second embodiments, the solution injection unit is actuated by using variations in pressure in the hard disk apparatus. The third embodiment includes a mechanical interlocking mechanism, which is interlocked with a fastener, such as a screw, for securing a lid of the enclosure. Specifically, referring to FIGS. 6 and 7, a hard disk apparatus 300 according to the third embodiment of the present invention has a lid 324 fixed to an enclosure 320 with the fastener 326. The fastener 326 is provided with an interlocking mechanism 330, such as a latchet mechanism. The latchet mechanism 330 in this embodiment is fitted loosely on the fastener 326, and is provided with a movable ring or plunger 332 formed with teeth, which are configured with inclined surfaces and radially extending surfaces on the side thereof.

The inclined surfaces are positioned to allow the plunger 332 to move inwardly, but latch if the plunger 332 is moved outwardly. Fixation of the movable plunger 332 to the fixing screw 326 is achieved by a retaining ring 334, which prevents the relative rotational movement of the plunger 332 in relation to the fastener 326. At the position facing the movable plunger 332, there is provided a divided fixed ring 336 formed with complementary teeth, which include inclined surfaces and radially extending surfaces on the side thereof, that restrain the plunger 332 from moving outwardly relative to the ring 336. The ring 336 is restrained from moving axially (inwardly/outwardly) relative to the fastener 326 by limiting its movement with an upper and a lower walls 338 provided on a cylindrical frame 340, but is free to move in the radial direction (substantially perpendicularly to the displacement direction of the fastener 326), against a bias provided by one or more springs 342 or the like positioned between the ring 336 and the cylindrical frame 340.

In the third embodiment, a solution container 380 formed of a flexible film or the like can be integrated with the cylindrical frame 340. As in the previous embodiments, the container 380 has one or more injection ports 382 with a pressure operated sealing film 384 closing the container. The cylindrical frame 340 is supported at a predetermined position of the enclosure 320 by a guide member (not shown) so that the vertical movement is not restrained, but the rotational movement is. The upper portion of the solution container 380 formed of the flexible film or the like is held by a fixed frame 344. The enclosure 320 accommodates the hard disk 140, the head arm 142, the magnetic head 144, etc., as described in the first embodiment therein.

With the latchet mechanism 330 in this arrangement, when the fastener 326 is screwed for assembling the lid 324, the plunger 332 is pressed inwardly, the bevel configuration of the teeth on the plunger 332 and the fixed ring 336 abutting against each other but allowing the plunger 332 to slide and move inwardly relative thereto. As the plunger is able to move downwardly relative to the cylindrical frame 340, the frame 340 does not move downwardly. When an attempt is made to open the enclosure 320 of the hard disk apparatus 300 by removing the lid 324 (loosening the fastener 326), the fastener 326 is moved outwardly (upwardly as illustrated in the figure), which moves the plunger 332 outwardly. The radially extending surfaces of the teeth engage each other, pulling the fixed ring 336 outwardly (upwardly referring to FIG. 7) together with the cylindrical frame 340. Consequently, the solution container 380 integrated in the lower portion of the cylindrical frame 340 is pressurized with respect to the fixed frame 344. Therefore, when the solution container 380 is pressurized via the latchet mechanism 330, the solution is squirted out and dispersed from the injection port 382 onto the main surface of the magnetic storage medium 140, melting or dissolving the magnetic layer 140a/lubricant layer 140b to disable the medium 140.

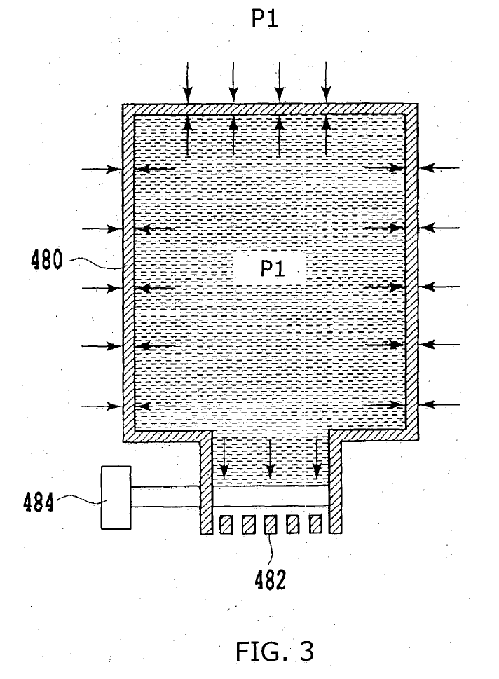

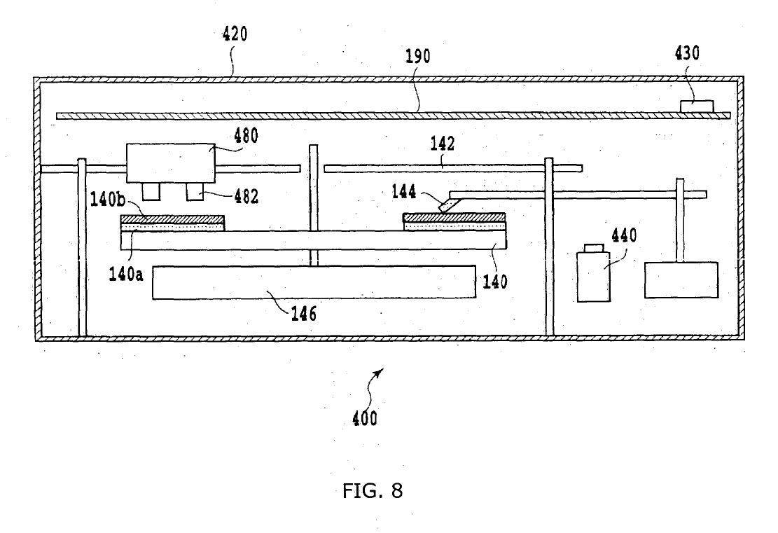

Referring to FIG. 3 and FIG. 8, a hard disk apparatus 400 according to the fourth embodiment of the present invention includes a sensor 430 (FIG. 8) for detecting opening of its enclosure 420 (or lid) and an electric valve 484 provided on its solution container 480 for opening the same using an output signal from the sensor 430. The solution container 480, which is formed with an injection port 482, as shown in FIG. 3, is filled at a high pressure with a solution that can melt or dissolve at least the magnetic layer/lubrication layer of the magnetic storage medium. The valve 484 seal the container 480 it in the normal operation. Since this system is operated by electricity, a primary or a secondary battery 440 should be provided in the hard disk apparatus 400.

The sensor 430 for detecting the opening can be any sensor of the following types:

1) Pressure Sensor: The enclosure 420 of the hard disk apparatus 400 is sealed, and the pressure in the enclosure 420 is maintained in the higher pressure or the reduced pressure sufficiently in comparison with the normal pressure, so that the pressure in the enclosure 420 changing to the normal pressure is detected when the enclosure 420 is opened;

2) Oxygen Sensor: The enclosure 420 of the hard disk apparatus 400 is sealed in the enclosure 420 with oxygen free atmosphere, such as with argon, and kept in the oxygen-free state. When the enclosure 420 opens to the atmosphere, oxygen in the enclosure 420 can be detected;

3) Impact Sensor: The enclosure 420 of the hard disk apparatus 400 is completely sealed by, for example, ultrasonic welding or the like, and mechanical abnormal vibrations generated when attempt is made to open by using a tool can be detected;

4) Light Receiving Sensor: The enclosure 420 of the hard disk apparatus 400 is completely light-shielded, and opening of the enclosure 420 is detected by detecting the outside light entering the enclosure 420 when it is opened;

5) Resistance Variation Sensor: An electric conductor having a specific resistance is provided on the surface of the enclosure 420 of the hard disk apparatus 400, electrodes for measuring the resistance are disposed on the respective surfaces of the electric conductor, and the variations in resistance value between the electrodes can be measured to determine whether the enclosure 420 is opened when there is a significant variation in the resistance value.

As described above, in the hard disk apparatus 400 according to the fourth embodiment of the present invention, when the enclosure 420 opening is detected by the sensor 430, the electric sealing valve 484 can be triggered according to the signal from the sensor, and the solution can be dispersed through the injection port 482 of the solution container 480, which is maintained at a higher pressure than the enclosure 420. The solution from the container 480 falls onto the main surface of the magnetic storage medium 140, dissolving or melting the magnetic layer 140a/lubricant layer 140b to render the medium 140 unreadable.

The solution container according to the above-described embodiments can contain fine particles (for example, glass beads) that can adhere to the main surface of the magnetic storage medium, as well as the solution that can melt at the surface of the magnetic storage medium. This renders the medium useless.

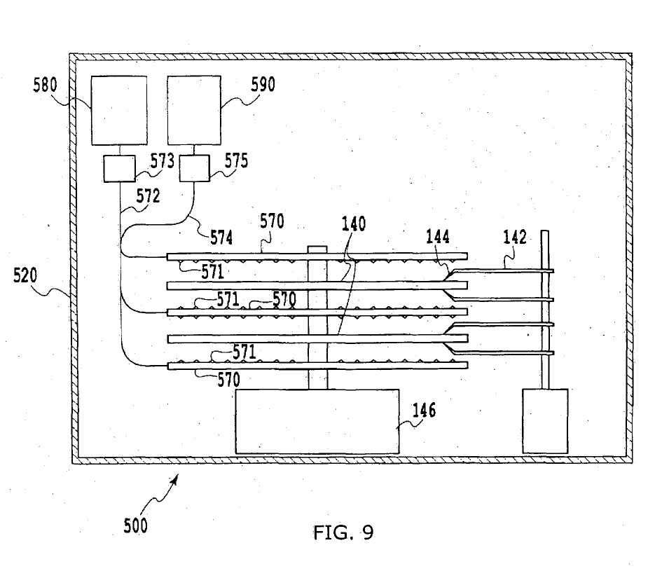

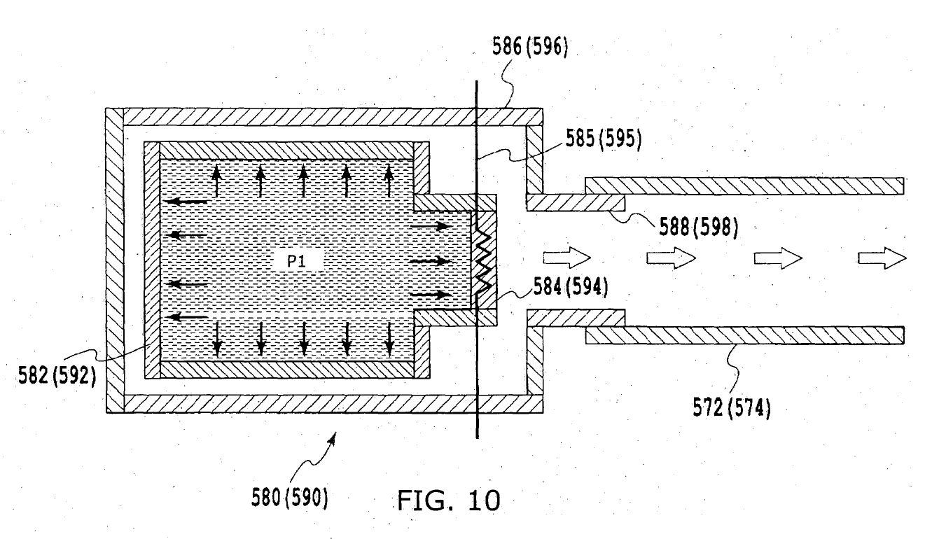

Referring to FIGS. 9-11, a hard disk apparatus 50O according to a fifth embodiment of the present invention has an enclosure 520 containing a first solution container 580 containing an acidic solution that can reach and melt at least the magnetic layer of the hard disks 140 and a second solution container 590 containing an alkaline solution for neutralizing the acidic solution. To inject the acidic solution in the first solution container 580 and the alkaline solution in the second solution container 590 onto the main surface of the hard disks 140 in response to opening of the enclosure 520, nozzle pipes 570 (three illustrated in this embodiment) having a plurality of nozzles 571 opening toward the main surfaces of the hard disks 140, and pipings 572, 574 formed of vinyl hose for connecting the nozzle pipes 570 with respect to the outlets of the first solution container 580 and the second solution container 590, respectively, are provided. The pipings 572, 574 each can be provided with a check valve 573, 575.

The first and second solution containers 580, 590 (reference number in the parenthesis refers to the second container 590) each can have a double-walled configuration. An internal container 582 (592) can be filled with the acidic solution (the alkaline solution) at pressure P1, which is higher than 1 ATM, respectively. The internal container 582 (592) includes a heater 585 (595) and at least one outlet 584 (594). An external container 586 (596) surrounds the internal container 582 (592), spaced at a predetermined distance, and an outlet 588 (598) connects to the piping 572 (574).

In addition, like the fourth embodiment, a primary or a secondary battery can be provided in the hard disk apparatus 500 as a means for energizing the heater 585 (595), and the sensor provided therein.

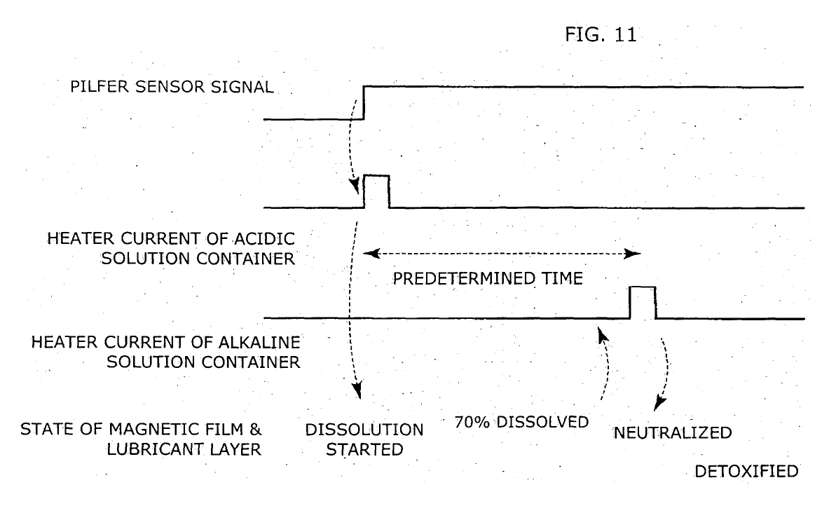

Referring to FIG. 11, the hard disk apparatus 500 according to the fifth embodiment of the present invention, detects the opening of the enclosure 520 thereof with the sensor, and the heater 585 provided at least at the outlet 584 (594) of the internal container 582 (592) of the first (second) solution container 580 (590) is energized by using the output signal from the sensor. The internal container 582 (592) can be made of glass. The stress due to the difference in thermal expansion coefficients between the heater 585 and the glass is generated in the solution container 580 (590) due to abrupt heating to break the outlet 584 (594) and spray the acidic (alkaline) solution from the nozzle 571 via the piping 572 (574) and the nozzle pipe 570. The acidic solution dissolves the storage or magnetic layer and the lubricant layer of the magnetic storage medium.

In the embodiment of FIG. 11, the actuation of the heater 595 of the alkaline solution container 590 after the sensor detects the opening is delayed, i.e., energized after a predetermined period elapses after energizing the heater 585 of the acidic solution container 580, namely after the storage and lubricant layers have substantially dissolved. The alkaline solution is sprayed from the same nozzle 571 through the piping 574 and the same nozzle pipe 570 for neutralization. Therefore, detoxification is achieved to ensure safety.

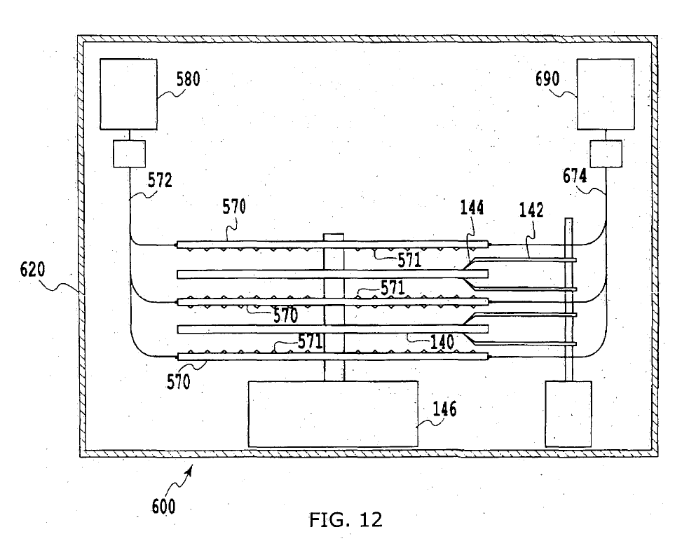

Referring to FIG. 12, a hard disk apparatus 600 according to a sixth embodiment of the present invention is substantially similar to the fifth embodiment, except that it uses alkaline powder instead of alkaline solution. According to the sixth embodiment, the alkaline powder is encapsulated in the internal container of a double-walled alkaline powder container 690, at a pressure higher than 1 ATM, like that of the fifth embodiment. The outlet of the external container is connected to the other end of a nozzle pipe 570, via piping 674.

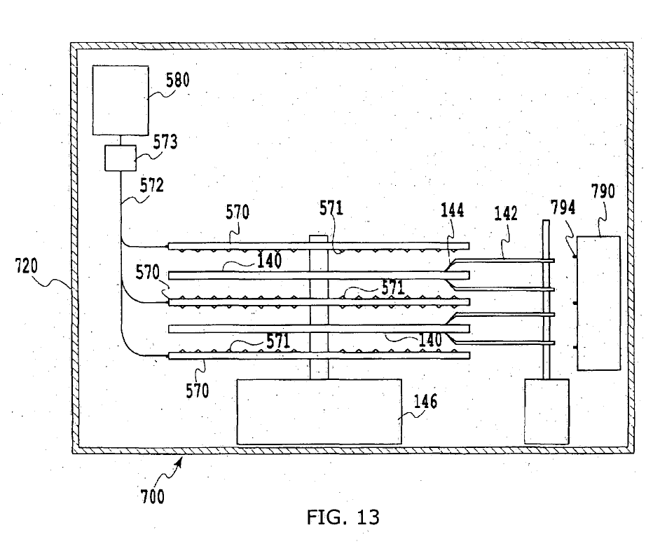

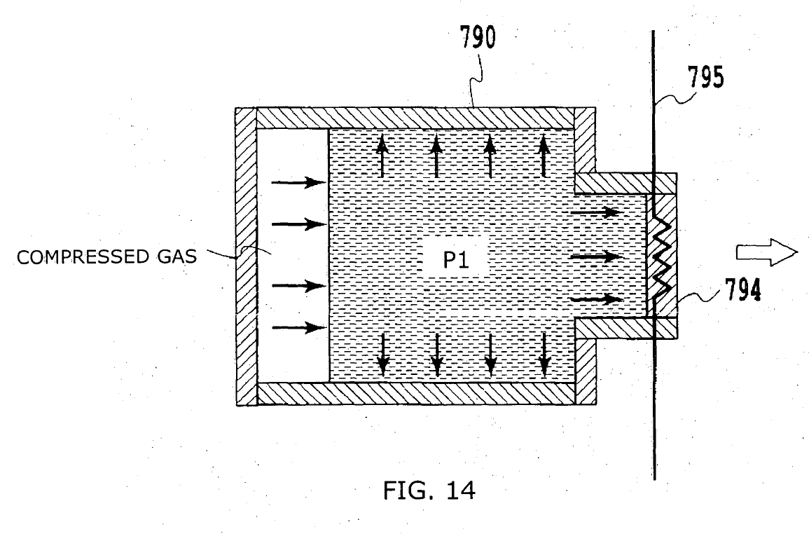

Referring to FIGS. 13 and 14, a hard disk apparatus 700 according to the seventh embodiment of the present invention is similar to the sixth embodiment, except that it uses a single-walled alkaline container 790 formed of glass (FIG. 14) instead of the double-walled glass container used in the sixth embodiment. A heater 795 is provided at an outlet 794 of the container 790. The alkaline powder container 790 is filled with gas pressurized to an air pressure higher than 1 ATM, together with alkaline powder. The outlet 794 is not connected to any piping. Instead, the outlets 794 are directed so that the alkaline powder is dispersed in the enclosure 702 toward the main surfaces of the media 140.

In the sixth and seventh embodiments, as in the fifth embodiment, when the sensor detects the opening of the enclosures 620 and, the heater 585 provided at the outlet 584 of the internal container 582 of the acidic solution container 580 is energized according to the output signal from the sensor. When the outlet 584 is broken, the acidic solution is sprayed through the nozzle 571. Then, when a predetermined period passes after the heater 585 of the acidic solution container 580 is energized, the heater 695, 795 of the alkaline powder container 690, 790 is energized.

In the sixth embodiment, the outlet 694 of the alkaline powder container 690 is broken, and the alkaline powder is sprayed through the nozzle 571 through the piping 674 and the nozzle pipe 570 to spread evenly on the surface of the hard disk 140 and fully neutralize the same. In the seventh embodiment, the outlets 794 of the alkaline powder container 790 are broken so that the alkaline powder is sprayed along the interior of the enclosure 720, not only on the magnetic storage media 140, to globally neutralize the hard disk components. Therefore, detoxification is achieved to ensure safety.

Although the containers described above with respect to the fifth, sixth, and seventh embodiments can be formed of glass, they can be formed of other material, such as ceramic or polymer resin.

According to the present invention, even when an attempt is made to open the hard disk apparatus and read contents information stored in the hard disk, stored content in the magnetic storage medium is rendered unreadable or useless by a substance that can melt or dissolve at least the storage layer of the magnetic storage medium. Although the preferred embodiment has been described in conjunction with destructive substance, the present invention can be equally applicable with a non-destructive substance that renders the magnetic recording medium unreadable. Thus reading of the contents is completely prevented, to thwart any attempt to lift protected information. In addition, since the solution used to render the disk useless is neutralized, safety can be ensured.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosures of the priority applications, JP 2002-210183 and JP 2003-016581, in their entirety, including the drawings, claims, and the specification thereof, are incorporated herein by reference.

What is claimed is:

1. A security-protected hard disk apparatus comprising:
a magnetic storage medium;
a first container containing a substance that renders the magnetic storage medium unreadable or unusable when applied thereto;
an enclosure enclosing the magnetic storage medium and the container; and
releasing means for releasing the substance in the container to the surface of the magnetic storage medium in response to opening of the enclosure to render the magnetic storage medium unreadable or unusable.

2. A security-protected hard disk apparatus according to claim 1, wherein the enclosure is sealed to maintain a set pressure, and the pressure in the enclosure is set substantially the same as that of the container, but higher than the ambient or atmospheric pressure, and wherein the release means releases the substance when the pressure in the container becomes higher than the pressure in the enclosure.

3. A security-protected hard disk apparatus according to claim 1, wherein the container includes a port, which is arranged to face the surface of the magnetic storage medium, and the port includes a seal that opens based on the pressure difference between the container and the ambient or atmospheric pressure surrounding the container.

4. A security-protected hard disk apparatus according to claim 1, wherein the enclosure comprises an inner enclosure sealingly enclosing the container and the magnetic storage medium, and an outer enclosure sealingly enclosing the inner enclosure, wherein the inner enclosure has a movable portion adapted to press the container when the pressure in the outer enclosure becomes higher than the pressure in the inner enclosure.

5. A security-protected hard disk apparatus according to claim 4, wherein the pressure in the outer and inner enclosures is set lower than the ambient or atmospheric pressure.

6. A security-protected hard disk apparatus according to claim 4, wherein the container includes a port, which is arranged to face the surface of the magnetic storage medium, and the port includes a seal that opens when the movable portion presses the container.

7. A security-protected hard disk apparatus according to claim 1, wherein the enclosure has a lid that closes the enclosure and a fastener that secures the lid, and wherein the releasing means includes the fastener and an interlocking mechanism connected to the fastener and to the container, the interlocking mechanism allowing the fastener to be inserted inwardly and pressing the container to release the substance when an attempt is made to move the lid by releasing the fastener outwardly.

8. A security-protected hard disk apparatus according to claim 6, wherein the container includes a port, which is arranged to face the surface of the magnetic storage medium, and the port includes a seal that opens when the interlock mechanism presses the container.

9. A security-protected hard disk apparatus according to claim 1, wherein the release means includes a sensor for detecting opening of the enclosure and a valve actuating unit with a valve for actuating the valve based on the sensor detection of the opening of the enclosure, the valve actuating unit with the valve being associated with the container for releasing the substance.

10. A security-protected hard disk apparatus according to claim 1, wherein the substance dissolves or melts a magnetic storage layer of the magnetic storage medium.

11. A security-protected hard disk apparatus according to claim 10, wherein the substance also includes fine particles that adhere to the surface of the magnetic storage medium.

12. A security-protected hard disk apparatus according to claim 1, wherein the enclosure further includes a second container containing neutralizer for neutralizing the substance in the first container and neutralizer releasing means for releasing the neutralizer in the second container to the surface of the magnetic storage medium in response to opening of the enclosure.

13. A security-protected hard disk apparatus according to claim 12, wherein the substance is acid for dissolving or melting a magnetic storage layer of the magnetic storage medium and the neutralizer is alkaline for neutralizing the acid.

14. A security-protected hard disk apparatus according to claim 13, wherein the alkaline releasing means releases the alkaline after a predetermined period elapses after the acid is released.

15. A security-protected hard disk apparatus according to claim 13, further including a sensor for detecting opening of the enclosure, wherein the acid releasing means and the alkaline releasing means each include the sensor and a heater for heating the respective first or second container to release the content therein based on the detection of the enclosure opening, wherein heater of the second container heats after a predetermined period lapses after the detection of the enclosure opening.

16. A security-protected hard disk apparatus according to claim 13, wherein each of the first and second containers has a double-walled configuration, including an internal container and an outer container enclosing the internal container, the internal container sealingly containing the respective acid or alkaline and set at a pressure of 1 ATM or higher, and including a heater for heating at least a portion of the internal container.

17. A security-protected hard disk apparatus according to claim 13, wherein the first container has a double-walled configuration, including an inner container sealingly containing the acid at a pressure of 1 ATM or higher, and an outer container holding the inner container, and wherein the second container sealingly contains the alkaline at a pressure of 1 ATM or higher, and the second container and the internal container of the first container each include a heater for unsealing the respective container.

18. A security-protected hard disk apparatus according to claim 16, the acid releasing means includes a nozzle pipe having a plurality of nozzles opening toward the surface of the magnetic storage medium, and piping connecting the nozzle pipe to an outlet of the outer container of the first container, and the alkaline releasing means includes piping connecting the nozzle pipe to an outlet of the outer container of the second container.

19. A security-protected hard disk apparatus according to claim 17, wherein the acid releasing means includes a nozzle pipe having a plurality of nozzles opening toward the surface of the magnetic storage medium, and piping connecting the nozzle pipe to an outlet of the outer container of the first container.

20. A security-protected hard disk apparatus according to claim 19, wherein the alkaline releasing means also includes piping for connecting the nozzle pipe to the outlet of the alkaline container.

21. A security-protected hard disk apparatus according to 16, wherein at least the inner containers of the first and second containers are formed of glass, ceramic, or polymer resin.

22. A security-protected hard disk apparatus according to 17, wherein the second-container and at least the inner containers of the first container are formed of glass, ceramic, or polymer resin.

23. A security-protected hard disk apparatus for a magnetic storage medium, comprising:
a first container containing a substance that renders the magnetic storage medium unreadable or unusable when applied thereto;
an enclosure for enclosing the container and the magnetic storage; and
releasing means for releasing the substance in the container to the surface of the magnetic storage medium in response to opening of the enclosure to render the magnetic storage medium unreadable or unusable.

24. A security-protected hard disk apparatus for a magnetic storage medium according to claim 23, further including a second container and neutralizer releasing means in the enclosure, the second container containing a neutralizer for neutralizing the substance in the first container and the neutralizer releasing means is for releasing the neutralizer in the second container to the surface of the magnetic storage medium in response to opening of the enclosure.

25 A method of disabling a magnetic storage medium to prevent reading or accessing thereof, comprising the steps of:
enclosing the magnetic storage in an enclosure;
providing in the enclosure a container containing a substance that renders the magnetic storage medium unreadable or unusable when applied thereto; and
releasing the substance in the container to the surface of the magnetic storage medium when the enclosure is opened or exposed to the ambient or atmospheric pressure to render the magnetic storage medium unreadable or unusable.

26. A method according to claim 25, further including the step of releasing a neutralizer at least to the magnetic storage medium to neutralize the substance.

27. A method according to claim 25, further including the step of releasing a neutralizer to the inside of the enclosure to neutralize the substance.
